(19) United States
(12) Patent Application Publication
(10) Pub. No.: US 2024/0421653 A1
(43) Pub. Date: Dec. 19, 2024

(54) ELECTRIC MACHINE FOR DRIVING A MOTOR VEHICLE

(71) Applicant: ZF Friedrichshafen AG, Friedrichshafen (DE)

(72) Inventors: Gerhard Höring, Hagnau am Bodensee (DE); Marcel Störkle, Ravensburg (DE)

(73) Assignee: ZF Friedrichshafen AG, Friedrichshafen (DE)

(21) Appl. No.: 18/743,706

(22) Filed: Jun. 14, 2024

(30) Foreign Application Priority Data
Jun. 16, 2023 (DE) 10 2023 205 677.1

(51) Int. Cl. H02K 5/20

(52) U.S. Cl. CPC H02K 5/20; H02K 2205/09

(57) ABSTRACT

An electrical machine has a machine housing accommodating a rotor, a stator, and an output shaft. A venting element has a collecting chamber, an inlet, and at least one outlet, where the inlet is connected to the interior space of the housing, within which air can expand and increase in pressure when the electrical machine heats up during operation. The outlet(s) of the venting element connects to an external environment. The collecting chamber is between the inlet and the outlet(s) and is connected via the inlet to the interior of the housing and via the at least one outlet to the environment. The venting element connects the interior to the environment so that air can escape from the interior via the inlet, the collecting chamber, and the outlet(s) to the environment when the internal pressure is higher than the pressure of the external environment.

The invention relates to an electrical machine for driving a motor vehicle.

An electrical machine for driving a motor vehicle heats up and cools down again. A volume of air that is enclosed within the interior of the electrical machine and expands or contracts due to the different temperatures can cause undesirable pressure changes in the interior of the electrical machine. Therefore, there is a need to create a pressure equalization between the interior of the electrical machine and the external environment of the electrical machine. Various solutions are known from the state of the art to enable pressure equalization. In the case of hose ventilation systems, additional work is required to install a hose element in a drying room. If the drying room is formed by a driver's cab, this solution does not work odorlessly in the room used. With an alternative membrane solution, oil droplets can clog micropores in the membrane over time, which means that this solution cannot be used without maintenance. With a simple air vent with rain cover and strainer, there is a risk of pressurized water entering the interior of the electrical machine.

If the electrical machine has an oil bath for lubricating and/or cooling its components, the problem can arise that an opening for pressure equalization is exposed to an oil mist from the inside and water or water vapor from the outside. The water or water vapor must not get into the interior of the electrical machine, whereas the oil mist or its oil content must not get into the external environment of the electrical machine or into the environment.

US 2003/0098204 A1 discloses a venting device for a drive train of an electric vehicle with an electric motor and with a transmission connected to the electric motor. The venting device comprises a venting chamber provided above a connecting portion that connects an electric motor housing and a transmission housing. Further, the venting device comprises a first venting passage providing a connection between the venting chamber and an inside of the electric motor housing, and a second venting passage providing a connection between the venting chamber and a lubricating oil separating chamber formed in the transmission housing.

JP 2013-177952 A further discloses a power transmission apparatus comprising an oil-cooled motor having a rotary shaft as an output shaft to which power of a motor is transmitted, a transmission to which power is transmitted from the rotary shaft, and a housing having a rear bracket formed between a motor chamber for receiving the motor and a transmission chamber for receiving the transmission. A drain opening is formed in the lower part of a gearbox housing to accommodate the gearbox in order to open the gearbox chamber to the atmosphere. A connection opening is formed in the rear bracket to enable a connection between the motor chamber and the transmission chamber. An air vent is also fitted to filter the air flowing through the connection opening.

One task of the present invention can be seen in providing an electrical machine with a venting device which enables venting of the electrical machine in a particularly effective and simple manner and at least reduces the ingress of foreign bodies. The object is achieved by the scope of the independent claims. Advantageous embodiments are the scope of the dependent claims, the following description and the figures.

According to the present invention, it is proposed to attach to an electrical machine a particularly large-volume element with a chamber which makes it more difficult for pressurized water, water, and water vapor etc. to penetrate, particularly due to its shape. In this sense, the present invention provides an electrical machine for driving a motor vehicle. The electrical machine comprises a machine housing for accommodating a rotor, a stator, and an output shaft of the electrical machine, and a venting element with a collecting chamber, with an inlet and with at least one outlet.

The machine housing forms an interior space within which air is located, which expands and increases an internal pressure prevailing within the interior space when the electrical machine heats up during operation. The inlet of the venting element is connected to the interior of the machine housing. The at least one outlet of the venting element is connected to an external environment of the electrical machine. The collecting chamber is arranged between the inlet and the at least one outlet and is connected to the interior of the machine housing via the inlet and to the external environment of the electrical machine via the at least one outlet. The venting element connects the interior with the external environment of the electrical machine in such a way that air escapes from the interior via the inlet, the collecting chamber and the at least one outlet into the external environment when the internal pressure is higher than a prevailing external pressure in the external environment. The venting element prevents foreign bodies from the external environment of the electrical machine that have penetrated into the collecting chamber from entering the interior of the machine housing via the inlet of the venting element.

The feature “connected” or “connects” is to be understood in particular as meaning that the connected elements are conductively connected to each other in such a way that air can flow from one element to the other and, if necessary, vice versa. In this way, pressure equalization between the connected elements is made possible. Foreign bodies can be, for example, solid particles such as dust. Furthermore, the foreign bodies can also be at least partially liquid, e.g., in the form of rainwater, water vapor, or pressurized water. Ice or snow can also be understood as foreign bodies in the sense of the present invention. The venting element enables maintenance-free, adaptive venting of the electrical machine with an oil bath. Over the service life, maintenance-free operation is also possible compared to a solution with a diaphragm. Furthermore, the venting element is easier to install compared to a solution with a hose vent known from the state of the art.

The shape of the collecting chamber can be designed to make it more difficult for pressurized water, water, and water vapor, etc. to penetrate. In particular, the at least one outlet can be arranged in a lower area of the collecting chamber so that any foreign particles that may have entered the collecting chamber from the external environment can leave the collecting chamber again by gravity. Furthermore, the collecting chamber can be closed at the sides and top with respect to the external environment so that no foreign bodies can enter the collecting chamber from the side or from above. This is only possible via the at least one outlet in the lower area, so that the majority of foreign bodies from the external environment are prevented from entering the venting device. In this sense, according to one embodiment, the at least one outlet is arranged on a lower surface of the collecting chamber, wherein an upper surface and a lateral surface of the collecting chamber are closed.

Preferably, the inlet is arranged in an upper area of the electrical machine, whereas the at least one outlet is arranged on the lower surface of the collecting chamber. The inlet is therefore arranged above the at least one outlet in the vertical direction. This results in a height difference between the inlet and at least one outlet. For example, if water enters the collecting chamber, it must overcome this height difference before it reaches the entrance to the interior of the machine housing. This risk only exists in particular if the collecting chamber is filled up to the inlet. This risk is particularly low due to the large-volume design of the collecting chamber. Water that has entered the collecting chamber will tend to flow out of the collecting chamber via at least one outlet rather than collecting up to the level of the entrance to the interior of the machine housing. This embodiment thus helps to ensure that large quantities of splash water can be collected in the collecting chamber and do not enter the interior of the electrical machine due to the height difference between the at least one outlet of the collecting chamber and the inlet on the electrical machine.

The collecting chamber can be a large-volume element (chamber) that makes it difficult for pressurized water, water, and water vapor, etc. in particular, to penetrate the interior of the machine housing. The large volume makes the electrical machine particularly insensitive to splash water, especially when driving, because large quantities of splash water can be absorbed in the collecting chamber before they reach the interior of the machine housing via the inlet. In this sense, according to one embodiment, it is provided that the collecting chamber forms a chamber interior whose volume is at least 10% of the oil volume located in the interior to be vented.

However, any water or water vapor that may have entered the collecting chamber cannot reach the oil chamber or interior of the machine housing through the drains or outlets and condensation surfaces, but it is instead separated out again. In this sense, according to one embodiment, the collecting chamber has at least one condensation surface and at least one guide rib. Water from water vapor that has entered the collecting chamber condenses on the condensation surface, wherein the condensed water is guided via the guide rib to the at least one outlet and flows out of the collecting chamber via the at least one outlet.

By providing several outlets (at least two) at spatially separated positions on the unit, the electrical machine is particularly resistant to cleaning with a water jet. In particular, water that has entered at one outlet can drain away at the other outlet. In this sense, according to one embodiment, a first outlet is arranged at a first position on the lower surface of the collecting chamber, whereas a second outlet is arranged at a second position on the lower surface of the collecting chamber. The first position is at a distance from the second position. In particular, the first position can be located in a horizontal direction of the electrical machine at one end of the collecting chamber and the second position at another end of the collecting chamber.

According to a further embodiment, the venting element comprises a first cup-shaped component and a second cup-shaped component, wherein the first cup-shaped component and the second cup-shaped component are detachably attached to one another and together form the collecting chamber. The first cup-shaped component can in particular form a lower part of the collecting chamber, in which the at least one outlet is also arranged. In particular, the second cup-shaped component can form an upper part of the collecting chamber. The lower cup-shaped component can also be an integral part of the machine housing. The two cup-shaped components according to this embodiment enable modularity, in particular with regard to the shape and/or size of the collecting chamber.

In this context, one of the two cup-shaped components can be replaced in order to enable differently sized chamber interiors of the collecting chamber. In particular, the second cup-shaped component that forms the upper part of the collecting chamber, in which the inlet is also located, can be replaced. In this sense, according to one embodiment, it is provided that one of the two cup-shaped components can be replaced by an alternative cup-shaped component with a different shape, so that a volume of the chamber interior is changed. This embodiment provides an adaptable venting element that can be fully integrated with the unit.

The attached ventilator can occupy unused spaces within the envelope of the unit thanks to its special design. In this sense, according to one embodiment, it is provided that an upper part of the machine housing has an outer surface which forms an inwardly directed bulge, wherein the venting element are arranged inside the bulge.

In the area of the inlet leading to the interior of the machine housing, the venting element can have a condensation section including a knitted wire mesh to cool an oil mist rising from the interior, and discharge it back into the unit via a funnel-shaped contour of the condensation section. Splashing oil and oil mist are returned to the unit by such a separating element and do not enter the environment. In this sense, in one embodiment, the venting element comprises a knitted wire mesh plug and a funnel-shaped oil condensation element with an upper opening and with a lower opening, wherein the lower opening is connected to the inlet of the venting element and wherein the upper opening is connected to the collecting chamber. The lower opening of the funnel-shaped oil condensation element has a smaller inner diameter than the upper opening. The knitted wire mesh plug is inserted into the upper opening and is permeable to air. An oil mist penetrating from the interior of the machine housing into the funnel-shaped oil condensation element cools down on an inner wall of the funnel-shaped oil condensation element and on the knitted wire mesh plug, so that oil contained in the oil mist condenses, sinks by gravity and flows into the interior via the inlet of the venting element.

An additional integrated labyrinth can act as a dust brake and prevent dust deposits on the knitted wire mesh stopper. In this sense, according to one embodiment, the venting element has a labyrinth structure, wherein the upper opening of the funnel-shaped oil condensation element is connected to the collecting chamber via the labyrinth structure, so that dust particles entering the collecting chamber from the external environment are prevented from reaching the knitted wire mesh plug via the labyrinth structure. In addition, the labyrinth structure forms a further obstacle for oil from the interior in the direction of the external environment, so that oil from the interior of the machine housing can be prevented from entering the environment with particular certainty.

Example embodiments of the invention are explained in more detail below using the schematic drawing, wherein the same or similar elements are provided with the same reference symbol. The following is shown in the figures below:

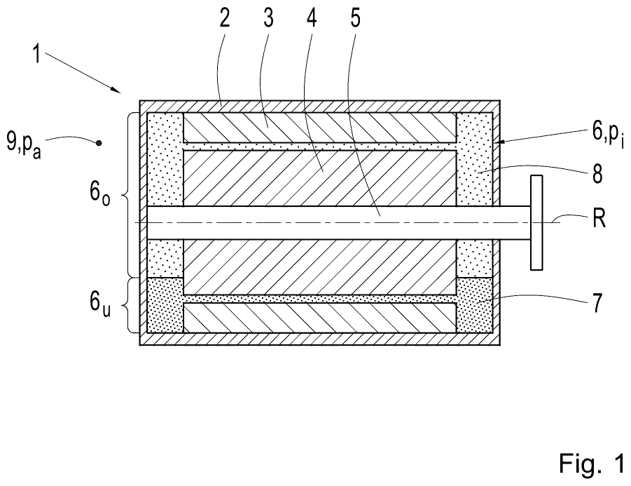

FIG. 1: a closed electrical machine,

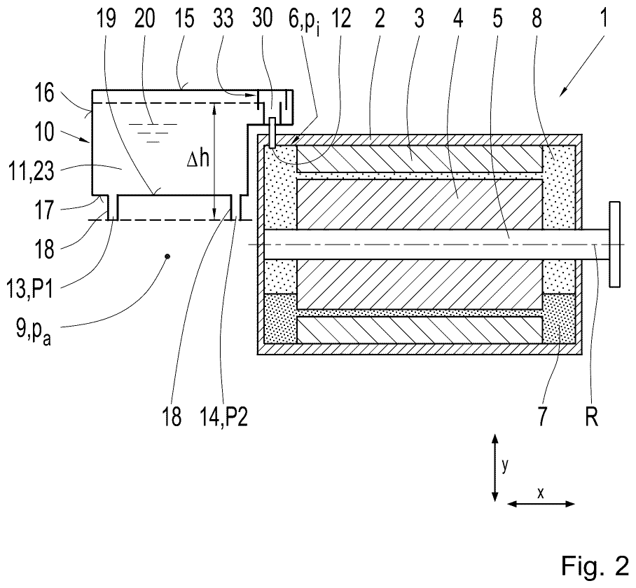

FIG. 2: a roughly schematic longitudinal sectional view of an exemplary embodiment of an electrical machine according to the invention with a venting element,

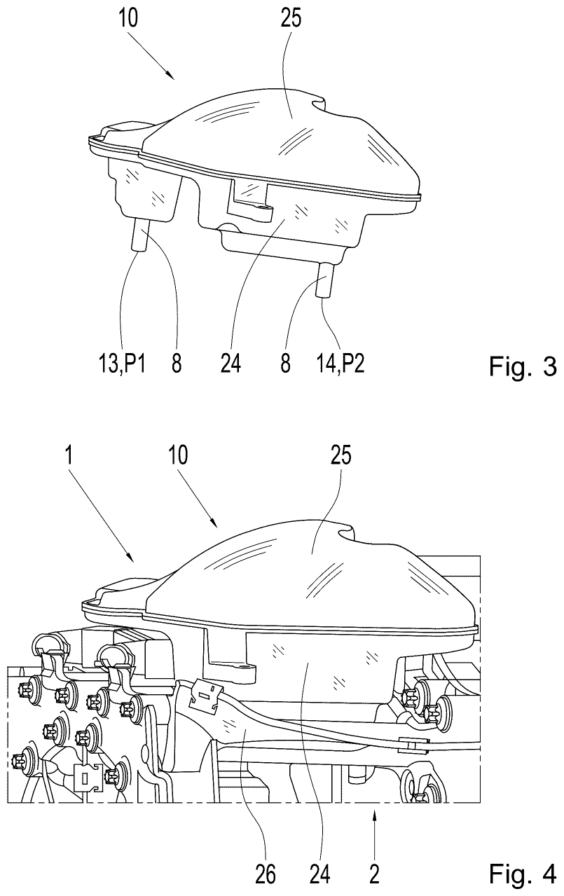

FIG. 3: a perspective view of a venting element for the electrical machine according to FIG. 2,

FIG. 4: a perspective view of the venting element according to FIG. 3 on an electrical machine,

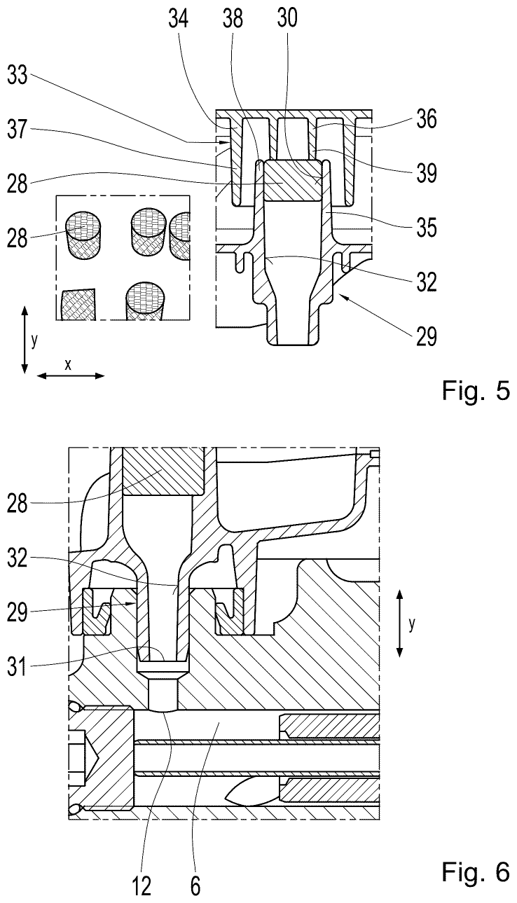

FIG. 5: a first partial sectional view of the venting element according to FIG. 3 in the area of an entrance to an inner chamber of the electrical machine according to FIG. 2,

FIG. 6: a second partial sectional view of the venting element according to FIG. 3 in the area of an entrance to an inner chamber of the electrical machine according to FIG. 2,

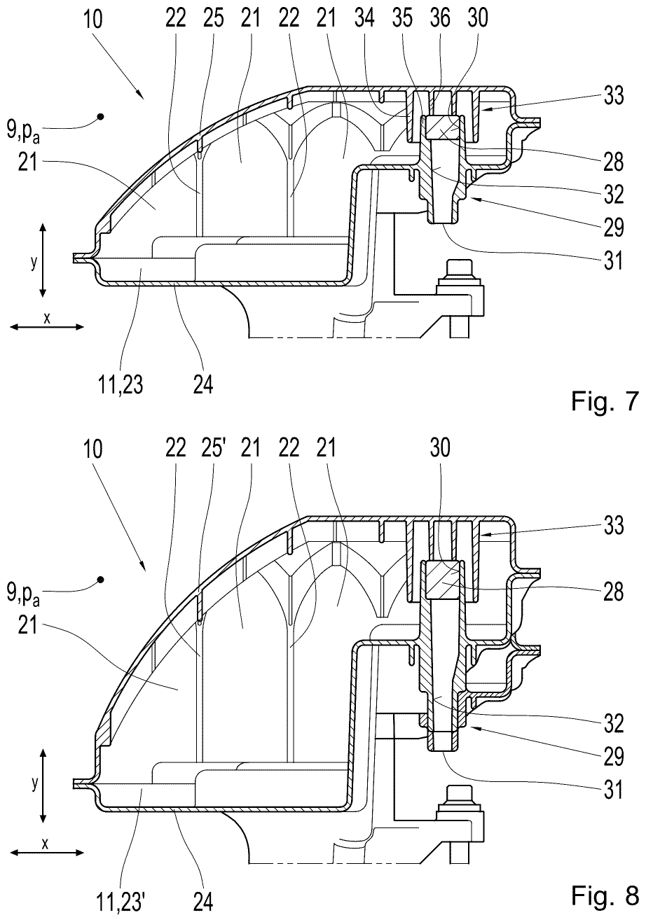

FIG. 7: a sectional view of the venting element according to FIG. 3 and

FIG. 8: a sectional view of the venting element according to FIG. 3 with an alternative upper cup-shaped component,

FIG. 1 shows an electrical machine 1 that can be used to drive a motor vehicle not shown. In particular, the electrical machine 1 comprises a machine housing 2, a stator 3, a rotor 4 and an output shaft 5, which can rotate about an axis of rotation R.

The machine housing 2 forms an interior 6, within which the stator 3, the rotor 4 and the output shaft 5 are accommodated. The interior 6 is closed. A lower part 6ᵤ of the interior 6 is filled with oil 7, which is used to cool and/or lubricate components of the electrical machine 1, e.g., to cool the stator 3 and the rotor 4. An upper part 6ₒ of the interior 6 is filled with air when the electrical machine 1 is at a standstill. When the electrical machine 1 heats up during operation, the oil 7 and the air also heat up. The air expands and increases the prevailing internal pressure pᵢ inside the interior 6. An external pressure pa, e.g., atmospheric pressure, prevails in an external environment 9 of the electrical machine 1.

There is a need to create a pressure equalization between the interior 6, within which the higher internal pressure pᵢ prevails, and the external environment 9, within which the lower external pressure pₐ prevails. This is achieved by a venting element 10, which is shown in FIGS. 2 to 8 and described in more detail below. Furthermore, the output shaft 5 rotates during operation of the electrical machine 1. As a result, some of the oil 7 is swirled around and forms an oil mist 8, i.e., finely atomized oil in the air, particularly in the upper part 6ₒ of the electrical machine. The oil mist 8 or its oil component should not enter the external environment 9 of the electrical machine 1 via the venting element 10. In the other direction, no foreign bodies from the external environment 9 should enter the interior 6 of the electrical machine 1 via the venting element 10, in particular no dust, rainwater, water vapor, pressurized water, ice, or snow.

The venting element 10 has a collecting chamber 11, an inlet 12 and, in the exemplary embodiment shown, a first outlet 13 and a second outlet 14. The inlet 12 of the venting element 11 is connected to the interior 6 of the machine housing 2. The first outlet 13 and the second inlet 14 of the venting element 10 are connected to the external environment 9 of the electrical machine 1. The collecting chamber 11 is located between the inlet 12 and the two outlets 13, 14. The collecting chamber 11 is connected to the interior 6 of the machine housing 2 via the inlet 12. The collecting chamber 11 is connected to the external environment 9 of the electrical machine 1 via the two outlets 13, 14.

The feature “connected” is to be understood in particular as meaning that the interconnected elements are conductively connected to each other in such a way that air can flow from one element to the other and, if necessary, vice versa, so that pressure equalization between the interconnected elements is made possible. In the present embodiment, the venting element 10 connects the interior 6 of the machine housing 2 with the external environment 9 of the electrical machine 1 in such a way that air escapes from the interior 6 via the inlet 12, the collecting chamber 11 and the two outlets 13, 14 into the external environment 9 when the internal pressure pᵢ prevailing in the interior 6 is higher than the external pressure pₐ prevailing in the external environment 9.

Foreign bodies that may have penetrated into the collecting chamber 11 from the external environment 9 of the electrical machine 1 are prevented from entering the interior 6 of the machine housing 2 via the inlet 12 by the venting element 10. Thus, the venting element 10 facilitates an air flow in an outward direction from the interior 6 into the external environment 9 in order to reduce the internal pressure pᵢ during operation of the electrical machine 1. At the same time, the venting element 10 prevents or at least makes it more difficult for foreign bodies (e.g., water or water vapor) from the external environment 9 to enter the interior 6 in an inward direction.

The collecting chamber 11 comprises an upper surface 15, a lateral surface 16 and a lower surface 17. The features “top” and “bottom” refer to a vertical direction y of the electrical machine 1, the feature “sideways” refers to a horizontal direction x (in which, for example, the axis of rotation R of the output shaft 5 can also run) of the electrical machine 1. The upper surface 15, the lateral surface 16, and the lower surface 17 simultaneously form the outer surfaces of the venting element 10. The upper surface 15 and the lateral surface 16 are closed towards the outside, i.e., towards the external environment 9. The collecting chamber 11 is only open on the lower surface 17, namely in the areas of the first outlet 13 and the second outlet 14. In the exemplary embodiment shown in FIG. 2, the two outlets 13, 14 are each arranged on an outer end section of a vertical tube 18, which projects downwards from the lower surface 17 in the vertical direction y and in particular ends flush or level with an inner lower base 19 of the collecting chamber 11. In this way, no foreign bodies 20 (e.g., water or water vapor) can penetrate into the collecting chamber 11 via the upper surface 15 and the lateral surface 16 into the collecting chamber 11 and consequently also cannot enter the interior 6 of the machine housing 2 via the inlet 12.

Foreign bodies 20, which may enter the collecting chamber 11 via the first outlet 13 and/or the second outlet 14, do not enter the interior 6 of the machine housing 2, at least not directly via the inlet 12. Instead, the foreign bodies 20 are first collected in the collecting chamber 11. The collecting chamber 11 has a large volume so that it can hold a particularly large quantity of foreign objects 20, which can collect in the collecting chamber 11 instead of entering the interior 6 of the machine housing 2 via the inlet 12. In the exemplary embodiment shown, a chamber interior 23 of the collecting chamber 11 has a volume that is greater than 10% of the oil volume 7 of the interior 6 to be vented.

The foreign bodies 20 can easily leave the collecting chamber 11 again via the two outlets 13, 14 by sinking by gravity towards the lower surface 17 or the base 19 and leaving the collecting chamber 11 again via the two vertical pipes 18 and the two outlets 13, 14. This is particularly possible if the foreign bodies 20 are small particles whose size is smaller than the diameter of the tubes 18. Liquid media such as water or the water content in water vapor can also sink particularly easily within the collecting chamber 11 by gravity towards the lower surface 17 or the base 19 and flow out of the collecting chamber 11 via the two vertical pipes 18 and the two outlets 13, 14.

By providing the two outlets 13, 14 at spatially separate positions P1, P2 of the venting element 10, the electrical machine 1 is particularly insensitive to cleaning with a water jet. In particular, water that has entered the first outlet 13 can drain out of the second outlet 14 and vice versa. In detail, the first outlet 13 is arranged at a first position P1 on the lower surface 17 of the collecting chamber 11, whereas the second outlet 14 is arranged at a second position P2 on the lower surface 17 of the collecting chamber 11. The first position P1 is located in the horizontal direction x at a distance from the second position P2. In the exemplary embodiment shown, the first position P1 in the horizontal direction x is located at one end of the collecting chamber 11 and the second position is located at another end of the collecting chamber 11.

An upper opening 30 of a labyrinth structure 33 of a funnel-shaped oil condensation element 29, described in more detail below, is connected to the inlet 12 to the inner region 6 of the machine housing 2 and is arranged in the region of the upper surface 12, whereas the two outlets 13, 14 are arranged on the lower surface 17 of the collecting chamber 11. Thus, the upper opening 30 of the labyrinth structure 33 is arranged in the vertical direction y above the two outlets 13, 14. This results in a height difference Δh between the upper opening 30 of the labyrinth structure 33 and the two outlets 13, 14. For example, if water 20 enters the collecting chamber 11, the water must overcome this height difference Δh before it reaches the inlet 12 to the interior 6 of the machine housing 2 via the upper opening 30 of the labyrinth structure 33. However, water 20 that has entered the collecting chamber 11 will tend to flow out of the collecting chamber 11 via one or both of the outlets 13, 14 rather than collecting up to the level of the upper opening 30 of the labyrinth structure 33. This means that large quantities of splash water in particular can be absorbed within the collecting chamber 11 and, due to the height difference Δh between the outlets 13, 14 and the upper opening 30 of the labyrinth structure 33, can only enter the interior 6 of the electrical machine 1 via the inlet 12 in very rare cases.

FIGS. 3 to 8 show details of a possible venting element 10 for the electrical machine 1 according to FIG. 2. As can be seen in FIGS. 7 and 8, the collecting chamber 11 can have several condensation surfaces 21 and several guide ribs 22. The water content of water vapor that has entered the collecting chamber 11 condenses on the condensation surfaces 21, wherein the condensed water is guided via the guide ribs 22 to the two outlets 13, 14 (FIG. 3) and flows out of the collecting chamber 11 via the two outlets 13, 14.

FIGS. 3, 4, 7, and 8 show that the venting element 10 can comprise a first cup-shaped component 24 and a second cup-shaped component 25, wherein the first cup-shaped component 24 and the second cup-shaped component 25 are detachably attached to one another and together form the collecting chamber 11. In the exemplary embodiment shown, the first cup-shaped component 24 forms a lower part of the collecting chamber 11, in which the two outlets 13, 14 are also arranged. The second cup-shaped component 25 forms an upper part of the collecting chamber 11, in which the upper opening 30 of the labyrinth structure 33 of the funnel-shaped oil condensation element 29 is also arranged, wherein the opening 30 is connected to the inlet 12 to the inner region 6 of the machine housing 2. In the exemplary embodiment shown in FIG. 7, the first cup-shaped component 24 is attached to the machine housing 2 of the electrical machine 1. The second cup-shaped component 25 is attached to the first cup-shaped component 24.

The second cup-shaped component 25 can be replaced by an alternative second cup-shaped component 25′ as shown in FIG. 8 in order to enable differently sized chamber interiors 23, 23′ of the collecting chamber 11. In the example shown, the alternative second cup-shaped component 25′ according to FIG. 8 is larger than the second cup-shaped component 25 according to FIG. 7. Thus, the alternative chamber interior 23′ according to FIG. 8 also has a larger volume than the chamber interior 23 according to FIG. 7.

FIG. 4 shows that the attached ventilator can occupy unused spaces within the envelope contour of the electrical machine 1 due to its special shape. An upper part of the machine housing 2 has an outer surface 26 (envelope contour), which forms an inwardly directed bulge 27. The venting element is arranged inside the bulge 27 and is attached to the machine housing 2 at this position.

FIGS. 5, 6, 7, and 8 show that the venting element 10 can have a knitted wire mesh plug 28 and a funnel-shaped oil condensation element 29 with an upper opening 30 and a lower opening 31 in the area of the inlet 12, which leads to the interior 6 of the machine housing 2, in order to cool an oil mist rising from the interior 6 and to discharge it back into the unit 1 via the funnel-shaped contour of the oil condensation element 29. Splashing oil and an oil mist are returned to the unit 1 by such a separating element 29 and do not enter the environment 9. The lower opening 31 is connected to the inlet 12 of the venting element 10 for this purpose. The upper opening 30, on the other hand, is connected to the collecting chamber 11. The lower opening 31 has a smaller inner diameter than the upper opening 30. The knitted wire mesh plug 28 is inserted into the upper opening 30 and is permeable to air. An oil mist penetrating from the interior 6 of the machine housing 2 into the funnel-shaped oil condensation element 29 cools down on an inner wall 32 of the funnel-shaped oil condensation element 29 and on the knitted wire mesh plug 28, so that oil contained in the oil mist condenses, sinks by gravity and flows out into the interior 6 via the inlet 12 of the venting element 10.

FIGS. 2, 5, 7, and 8 show that the venting element 10 can have a labyrinth structure 33. In particular, FIG. 5 shows that the labyrinth structure 33 in the exemplary embodiment shown comprises three sleeves 34 to 36 extending in the vertical direction y. An outer sleeve 34 radially surrounds a central sleeve 35. The middle sleeve 35 in turn radially surrounds an inner sleeve 36. In the exemplary embodiment shown, a radial direction of the sleeves 34 to 36 corresponds to the horizontal direction x. A labyrinth effect is achieved by the fact that in the vertical direction y, a freely extending end 37 of the outer sleeve 34 overlaps a freely extending end 38 of the middle sleeve 35 and that in the vertical direction y, a freely extending end 39 of the inner sleeve 36 extends to the freely extending end 38 of the middle sleeve 35.

The upper opening 30 of the funnel-shaped oil condensation element 29 forms an upper opening 30 of the labyrinth structure 33 and is connected to the collecting chamber 11 via the labyrinth structure 33 (see FIGS. 7 and 8), so that air can continue to flow between the opening and the collecting chamber 11. However, dust particles not shown which can enter the collecting chamber 11 from the external environment 9 via the two outlets 13, 14 (see FIG. 3) are prevented or at least hindered from reaching the knitted wire mesh plug 28 via the labyrinth structure 33 and being deposited on the knitted wire mesh plug 28. In addition, the labyrinth structure 33 forms a further obstacle for oil from the interior 6 in the direction of the external environment 9, so that oil from the interior 6 of the machine housing 2 can be prevented from entering the environment 9 with particular certainty.

### LIST OF REFERENCE NUMERALS

Δh Height difference
pₐ External pressure
pᵢ Internal pressure
P1 First outlet position
P2 Second outlet position
R Axis of rotation
x Horizontal direction
y Vertical direction
1 Electrical motor
2 Machine housing
3 Stator
4 Rotor
5 Output shaft
6 Interior
6ₒ Upper part of the interior
6ᵤ Lower part of the interior
7 Oil
8 Oil mist
9 External environment
10 Venting element
11 Collecting chamber
12 Inlet
13 First outlet
14 Second outlet
15 Upper surface
16 Side surface
17 Lower surface
18 Pipe
19 Inner base
20 Foreign bodies (water)
21 Condensation surfaces
22 Line ribs
23 Chamber interior
23′ Alternative chamber interior
24 first cup-shaped component
25 Second cut-shaped component
25′ Alternative second cup-shaped component
26 Outer surface of the machine housing
27 Bulge
28 Knitted wire mesh plug
29 Oil condensation element
30 Upper opening
31 Lower opening
32 Interior wall of the oil condensation element
33 Labyrinth structure
34 Outer sleeve
35 Middle sleeve
36 Internal sleeve
37 Freely extending end of the outer sleeve
38 Freely extending end of the middle sleeve
39 Freely extending end of the inner sleeve

1. An electrical machine (1) for driving a motor vehicle, the electrical machine (1) comprising
a machine housing (2) configured for accommodating a rotor (4), a stator (3), and an output shaft (5); and
a venting element (10) having a collecting chamber (11), an inlet (12), and at least one outlet (13, 14);
wherein
the machine housing (2) forms an interior space (6) within which air is located which expands and increases an internal pressure (pᵢ) prevailing within the interior space (6) when the electrical machine (1) heats up during operation;
the inlet (12) of the venting element (10) is connected to the interior (6) of the machine housing (2);
the at least one outlet (13, 14) of the venting element (10) is connected to an external environment (9) of the electrical machine (1);
the collecting chamber (11) is arranged between the inlet (12) and the at least one outlet (13, 14) and is connected via the inlet (12) to the interior (6) of the machine housing (2) and via the at least one outlet (13, 14) to the external environment (9) of the electrical machine (1);
the venting element (10) connects the interior (6) to the external environment (9) of the electrical machine (1) in such a way that air can escape from the interior (6) via the inlet (12), the collecting chamber (11) and the at least one outlet (12, 14) into the external environment (9) when the internal pressure (pᵢ) is higher than an external pressure (pₐ) prevailing in the external environment (9); and
the venting element (10) is configured to prevent foreign bodies (20) that have penetrated from the external environment (9) of the electrical machine (1) into the collecting chamber (11) from entering the interior (6) via the inlet (12).

2. The electrical machine (1) according to claim 1, wherein
the at least one outlet (13, 14) is arranged at a lower surface (17) of the collecting chamber (11), and
an upper surface (15) and a lateral surface (16) of the collecting chamber (11) are closed.

3. The electrical machine (1) according to claim 1, wherein the inlet (12) is arranged above the at least one outlet (13, 14).

4. The electrical machine (1) according to claim 1, wherein the collecting chamber (11) forms a chamber interior (23), the volume of which is greater than 10% of an oil volume (7) in the interior (6).

5. The electrical machine (1) according to claim 1, wherein
the collecting chamber (11) has a condensation surface (21) and a guide rib (22);
water from water vapor which has penetrated into the collecting chamber (11) condenses on the condensation surface (21); and
the condensed water is guided via the guide rib (22) to the at least one outlet (13, 14) and flows out of the collecting chamber (11) via the at least one outlet (13, 14).

6. The electrical machine (1) according to claim 2, wherein
a first outlet (13) is arranged at a first position (P1) on the lower surface (17) of the collecting chamber (11);
a second outlet (14) is arranged at a second position (P2) on the lower surface (17) of the collecting chamber (11); and
the first position (P1) is at a distance from the second position (P2).

7. The electrical machine (1) according to claim 1, wherein
the venting element (10) comprises a first cup-shaped component (24) and a second cup-shaped component (25); and
the first cup-shaped component (24) is detachably attached to the second cup-shaped component (25) and together the first cup-shaped component and the second cup-shaped component form the collecting chamber (11).

8. The electrical machine (1) according to claim 7, wherein one of the first and second cup-shaped components (25) is configured to be replaced by an alternative cup-shaped component (25′) having a different shape, so that a volume of the chamber interior (23/23′) is changed.

9. The electrical machine (1) according to claim 1, wherein
an upper part of the machine housing (2) has an outer surface (26) which forms an inwardly directed bulge (27); and
the venting element (10) is arranged inside the bulge (27).

10. The electrical machine (1) according to claim 1, wherein
the venting element (10) has a knitted wire mesh plug (28) and a funnel-shaped oil condensation element (29) with an upper opening (30) and a lower opening (31);
the lower opening (31) of the funnel-shaped oil condensation element is connected to the inlet (6) of the venting element (10);
the upper opening (30) of the funnel-shaped oil condensation element is connected to the collecting chamber (11);
the lower opening (31) of the funnel-shaped oil condensation element (29) has a smaller inner diameter than the upper opening (30);
the knitted wire mesh plug (28) is inserted into the upper opening (30),
the knitted wire mesh plug (28) is permeable to air; and
the venting element is configured so that an oil mist penetrating from the interior (6) of the machine housing (2) into the funnel-shaped oil condensation element (29) cools down on an inner wall (32) of the funnel-shaped oil condensation element (29) and on the knitted wire mesh plug (28), so that oil contained in the oil mist condenses, sinks by gravity and flows off into the interior (6) via the inlet (12) of the venting element (10).

11. The electrical machine (1) according to claim 10, wherein
the venting element (10) has a labyrinth structure (33); and
the upper opening (30) of the funnel-shaped oil condensation element (29) is connected to the collecting chamber (11) via the labyrinth structure (33), so that dust particles which enter the collecting chamber (11) from the external environment (9) are prevented from reaching the knitted wire mesh plug (28) via the labyrinth structure (33).
